(19) United States
(12) Patent Application Publication
(10) Pub. No.: US 2016/0201839 A1
(43) Pub. Date: Jul. 14, 2016

(54) Fuel Line Plug and Clasp for Model Airplane Engine

(71) Applicant: Robert H. Koehler, Secaucus, NJ (US)

(72) Inventor: Robert H. Koehler, Secaucus, NJ (US)

(21) Appl. No.: 14/596,894

(22) Filed: Jan. 14, 2015

(51) Int. Cl. F16L 55/11

(52) U.S. Cl. CPC F16L 55/1141

(57) ABSTRACT

A device designed to plug the flexible fuel fill line of a model airplane engine fuel tank to prevent it from leaking. The plug portion of the device is a sphere which fits into the flexible fuel fill line terminating at a cross member. The opposite end of the device contains a semi-circular clasp which attaches around the flexible fuel fill line so that the device stays attached to the flexible fuel fill line when the sphere plug portion is removed from the flexible fuel fill line.

### FIELD OF INVENTION

The present invention relates to a device which plugs the end of a flexible line used to fill or empty the fuel tank of a model airplane. Model Airplane fuel tanks are typically multi-line arrangements with a line feeding the engine, a line providing back-pressure into the fuel tank and a fill line used to fill or empty the fuel tank. Specifically, the line allocated for filing or emptying the fuel tank is commonly referred to as the fill line. A spherical end to the present invention operates as a plug when inserted into the fill line. A semi-circular clasp operates to retain the device to the fill line when the spherical end is removed from the fill line.

### BACKGROUND OF INVENTION

Remote control model airplanes powered by nitromethane or gasoline fuels require a fuel tank to supply the engine with fuel. These fuel tanks are sealed and often concealed inside the fuselage of the model. The fuel tank contains several small diameter brass pipes protruding out the front of the tank toward the engine. The brass pipes each have a specific function in operating the engine. In a nitromethane fuel engine, one brass tube feeds the engine carburetor with fuel, another brass tube provides pressure into the tank from the engine muffler exhaust and a third allows for adding or removing fuel from the fuel tank. Flexible fuel lines are attached to each of these brass pipes to allow connection with the various engine components and for filling and emptying the fuel tank.

Additionally, Cowls are often used on model airplanes. Cowls cover the engine and tank areas, either partially or completely, when installed. Cowls are difficult to remove and are not intended to be removed on a regular basis. As such, a fuel tank fill line is designed to protrude out of cowled engine arrangement and is often the only means by which fuel can be added or removed from the fuel tank without removing the cowl from the model airplane.

It is the object of the current invention to provide a device which will operate as a leak-free fuel tank fill line plug while also providing a retaining clasp which allows the spherical end of the device used as a plug to be inserted and removed from the flexible fuel line without having to remove the device from the flexible fuel line.

### SUMMARY OF INVENTION

A device used to plug the flexible fuel line coming off of a model airplane fuel tank. The device acts as a plug for the flexible fuel line by means of a spherical element inserted into the flexible fuel line. The device also features a clasp which fits around the flexible fuel line so that the device remains attached to the flexible fuel line when the spherical element is inserted into the flexible fuel line (during flight with a full fuel tank) or when this spherical element is removed (fuel tank is being emptied or re-filled).

### BRIEF DESCRIPTION OF DRAWINGS

FIG. 1 is an isometric view of the device.

FIG. 2 is a cut way view of the fuel tank engine arrangement in a model airplane.

FIG. 3 is a cross sectional view of the device inserted into a flexible hose.

FIG. 4 is a bottom view of a model airplane showing the device.

### DETAILED DESCRIPTION OF INVENTION

The present invention will now be described in terms of the presently preferred embodiment thereof as illustrated in the drawings. Those of ordinary skill in the art will recognize that may obvious modifications may be made thereto without departing from the spirit or scope of the present invention.

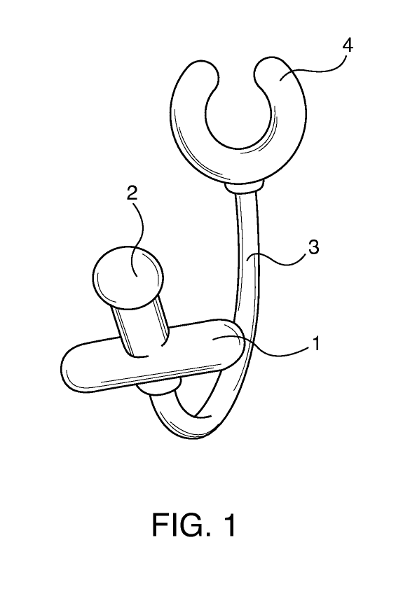

The present invention is directed to a device for plugging the fuel fill line of a fuel tank on a model airplane. The device comprises a generally elongated member (3) with a sphere (2) at one end of the device and a clasp (4) at the opposite end of the device. FIG. 1. A cross member (1) generally perpendicular to the elongated member (3) is located near the end of the device in proximity to the sphere (2). FIG. 1.

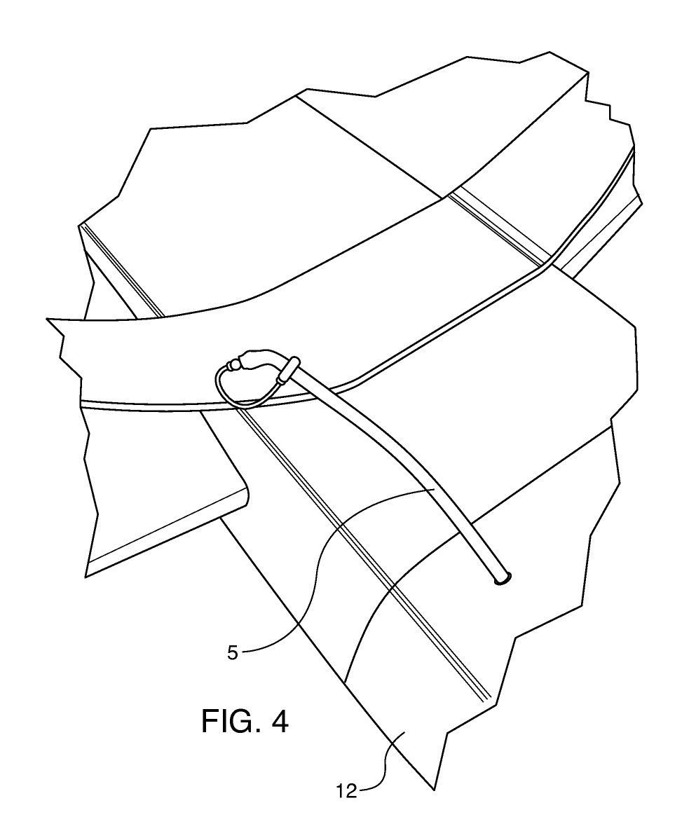

The sphere (2) fits into the fuel fill line (5) to provide a seal which prohibits fuel from leaking out of the fuel tank (12) through the fuel fill line. FIG. 3. The cross member (1) located on the elongated member (3) close to the sphere (2) is designed to provide a stop for the fuel fill line (5) inserted over the sphere (2) as well as a handle to be used when extracting the device from the fuel fill line (5). FIG. 1 and FIG. 3. The clasp (4) at the opposite end of the device, attaches around the fuel fill line (5) so that the device is retained on the fuel fill line (5) when the spherical end (2) is removed from the fuel fill line (5) when fuel is added or removed from the fuel tank (13). FIG. 3.

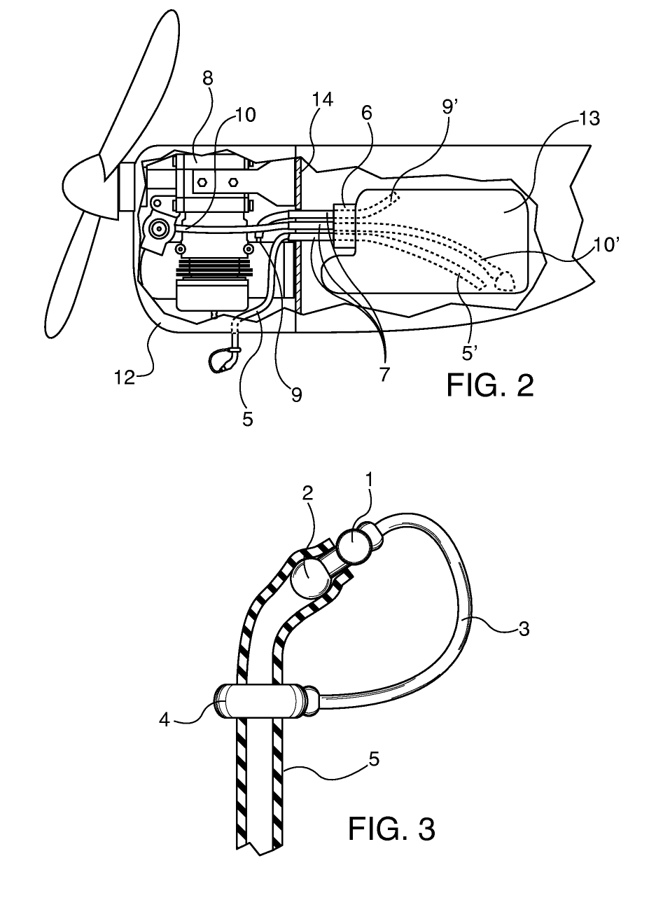

The fuel tank (13) in a model airplane is often inside the fuselage of the model with a plug (6) oriented in line with a hole in the firewall (14) of the model airplane. FIG. 2. The plug (6) in the fuel tank (13) has three openings which allow three brass tubes (7) to protrude out of the fuel tank (13) toward the front of the model airplane. FIG. 2. In front of this arrangement, the engine (8) for the model airplane sits on an engine mount. FIG. 2. Flexible tubes are attached to the protruding brass tubes (7) with their corresponding opposite ends inserted into the engine carburetor (10) and the back-pressure nipple of the muffler (9). FIG. 2. The third flexible line (5) coming off of the brass tubes (7) protruding out of the plug of the fuel tank (13) provides a means for the tank to be filled and emptied with fuel and is typically referred to as the fuel fill line. FIG. 2 and FIG. 4.

The model airplane engine (8) carburetor is connected to the fuel feed tube pipe (7) coming out of the fuel tank by a flexible fuel line (10) that feeds the engine (8) with fuel. FIG. 2. The portion of this fuel feed brass tube (7) which protrudes into the fuel tank is also fitted with a flexible fuel line (10′) which is weighted with a fuel pick up device, typically referred to as a clunk, so that the fuel line (10′) will move inside the fuel tank (13) during flight as the model airplane changes orientation. FIG. 2.

The tank pressure brass tube (7) protruding from the fuel tank (13) is connected to a nipple on the model airplane engine muffler by a flexible fuel line (9) and provides pressure into the fuel tank (13) while the engine is running. FIG. 2. The portion of the tank pressure brass tubing (9′) which protrudes into the fuel tank (13) is typically located at the top of the fuel tank (13) and bent upward to where it is almost touching the inside top surface of the fuel tank (13). FIG. 2.

The brass pipe (7) protruding from the fuel tank which allows the fuel tank to be filled and emptied extends into the fuel tank by means of a flexible hose (5′) toward the bottom of the fuel tank (13). FIG. 2. A flexible fuel fill line (5) is attached to this fill line pipe (7) as it exits the fuel tank. FIG. 2. This flexible fuel fill line (5) needs to be plugged when there is fuel in the fuel tank (13) or the fuel will leak out this fuel fill line (5). FIG. 2. Usually, screws or other items are used as a make-shift plug for the fuel tank fill line; these screws and other items often leak.

Often, a cowl (12) is affixed to the front of the model airplane fuselage completely encapsulating the engine (8) and blocking off access to the firewall (14) and the fuel tank (13) plug (6). FIG. 2 and FIG. 4. In this arrangement, the flexible line acting as the fill line (5) is attached to the corresponding brass pipe (7) protruding from the fuel tank (13) and hung out of the bottom back portion of the cowl (12) to allow access for filing or emptying the model airplane fuel tank (13). FIG. 2 and FIG. 4.

At the end of the flexible fuel tank fill line (5) protruding from the engine cowl (12) of the model airplane, the instant device is affixed. FIG. 2 and FIG. 4. Specifically, the clasp (4) at one end of the device is attached around the flexible fuel tank fill line (5) so as to retain the device to the fuel tank fill line (5) whether the spherical element (2) acting as the plug for the fuel fill line is inserted in the fuel tank fill line (5) or not. FIG. 2 and FIG. 4. The spherical element (2) can then be inserted and removed into the flexible fuel tank fill line (5) as necessary without removing the device from the flexible fuel fill line (5) with the aid of the cross member (2). FIG. 3.

The present device may also be used in other model crafts outfitted with internal combustion nitromethane or gasoline powered engines such as a car, boat, helicopter or drone.

Those of ordinary skill in the art will recognize that the embodiments just described merely illustrate the principles of the present invention. Many obvious modifications may be made thereto without departing from the spirit or scope of the invention as set forth in the appended claims.

What is claimed is:

1. A device for plugging the end of a flexible fuel line on a model airplane engine comprising:
(a) an elongated member having a front end and a back end and extending generally along a curved axis;
(b) a spherical element attached to the front end of the elongated member to plug the end of the flexible fuel line;
(e) a cross member perpendicular to the elongated member attached to the front portion of the member near the spherical element to act as a handle and a stop for the fuel line; and
(d) a semi-circular clasp attached to the back end of the elongated member to act as a clasp around the fuel line.

2. A device as set forth in claim 1, wherein the elongated member extending generally along a curved axis follows a zigzag pattern.

3. A device as set forth in claim 1, wherein the device is fabricated using an injection mold process.

4. A device as set forth in claim 2, wherein the device is fabricated using an injection mold process.

5. A device as set forth in claim 1, wherein the device is made from a synthetic polymer.

6. A device as set forth in claim 2, wherein the device is made from a synthetic polymer.

7. A device as set forth in claim 1, wherein the device is made from Nylon 6-6.

8. A device as set forth in claim 2, wherein the device is made from Nylon 6-6.

9. A method for plugging the open end of a fuel fill line on a model airplane fuel tank, comprising:
providing a plugging device with an elongated member having a front end and a back end and extending generally along a curved axis; a spherical element attached to the front end of the elongated member; a cross member near the spherical element perpendicular to the elongated member; a semi-circular clasp attached to the back end of the elongated member;
Attaching the semi-circular clasp of the plugging device around a fuel fill line extending out of a fuel tank of a model airplane;
Filling the model airplane fuel tank with fuel through the fuel fill line extending out of the fuel tank;
Inserting the spherical element of the plugging device into the fuel fill line extending out of the fuel tank up the cross member;
Removing the spherical element of the plugging device from the fuel fill line extending out of the fuel tank to remove unused fuel or to add more fuel;
re-inserting the spherical element of the plugging device into the fuel fill line extending out of the fuel tank up to the cross member.
